(19) United States
(12) Patent Application Publication
(10) Pub. No.: US 2015/0180998 A1
(43) Pub. Date: Jun. 25, 2015

(54) USER TERMINAL APPARATUS AND CONTROL METHOD THEREOF

(71) Applicant: Samsung Electronics Co., Ltd., Suwon-si (KR)

(72) Inventors: Hyung-rae CHO, Seoul (KR); Min-jeong MOON, Seoul (KR); Woo-yong CHANG, Yongin-si (KR); Chul-ho HAN, Seoul (KR)

(73) Assignee: Samsung Electronics Co., Ltd., Suwon-si (KR)

(21) Appl. No.: 14/138,770

(22) Filed: Dec. 23, 2013

(30) Foreign Application Priority Data
Dec. 21, 2013 (KR) 10-2012-0150760

(51) Int. Cl. H04L 29/08

(52) U.S. Cl. CPC H04L 67/306

(57) ABSTRACT

A user terminal apparatus is provided. The user terminal apparatus includes: a user input unit configured to receive a user input of contents; a display configured to display the contents; and a controller configured to change display arrangement of the contents according to user preference degrees of the contents, wherein the user preference degree is determined by the user input.

### CROSS-REFERENCE TO RELATED APPLICATIONS

This application claims the priority benefit of Korean Patent Application No. 10-2012-0150760, filed on Dec. 21, 2012, in the Korean Intellectual Property Office, the disclosure of which is incorporated herein by reference in its entirety.

### BACKGROUND

1. Field

Embodiments relate to providing a user terminal apparatus (user terminal) and a control method thereof, and more particularly, to providing a user terminal apparatus that generates and consumes contents in various forms, and a control method thereof.

2. Description of the Related Art

The recent development of electronic technologies has brought the development of various types of display apparatuses. In particular, display apparatuses, such as TVs, PCs, laptop computers, tablet PCs, portable phones, MP3 players, etc., have been distributed to and used in most general homes.

To meet needs of users who desire newer various functions, portable terminals such as tablet PCs, portable phones, or the like have been developed into forms having various functions of generating and consuming contents. For example, there have been increased content use acts that upload contents such as pictures, music, etc. and communicate the uploaded contents to other users through Social Networking Services (SNS).

However, contents generated and consumed by portable terminals are used through various routes, and thus it is easy to manage the contents.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

Exemplary embodiments provide a user terminal apparatus that stores and manages user's preferred contents selected through various attachments to contents separately from other contents, and a control method thereof.

According to an aspect of one or more exemplary embodiments, there is provided a user terminal apparatus including: a user input unit configured to receive a user input of contents; a display configured to display the contentsuser input; and a controller configured to change display arrangement of the contents according to user preference degrees of the contents, wherein the user preference degree is determined by the user input.

The user input of the contents may be at least one of a setting control of the contents reflecting user preference degrees of the contents, an editing control of the contents, a sharing control of the contents, and a content generation-relation control.

The controller may additionally store and manage the user preferred contents which is selected based on the user input in a preset preferred content folder.

The controller may change and display arrangement states of the user preferred contents in the preset preferred content folder according to the user preference degrees of the user preferred contents.

The user terminal apparatus may further include a first communicator configured to communicate with a social network services (SNS) server. The controller may provide a visual feedback that is to change sizes of the user preferred contents displayed in the preset preferred content folder in real time based on feedbacks of other users on user preferred contents uploaded to the SNS server.

The controller may display a UI that synchronizes and provides the feedbacks of the other users on the user preferred contents uploaded to the SNS server in real time.

The user terminal apparatus may further include a second communicator configured to communicate with a cloud server. The controller may automatically back the user preferred contents stored in the preset preferred content folder up to the cloud server.

When a user command to display preferred content folders of the other users is input, the controller may display a screen including preferred contents of the other users included in the preferred content folders of the other users.

The screen may include a time navigation graphical user interface (GUI) to select a time section for displaying the contents according to the user preference degrees of the contents. The controller may rearrange and display user preferred contents belonging to a time section selected according to a user input of the time navigation GUI.

According to an aspect of one or more exemplary embodiments, there is provided a server including: a communicator configured to communicate with a user terminal; a storage unit configured to store information about contents according to user preference degrees of the contents of preset time sections received from the user terminal; and a controller configured to, when there is a request of the user terminal to control transmission of information about contents according to the user preference degrees of the contents corresponding to a time section corresponding to the request to the user terminal. The user preference degree is determined by a user input.

According to an aspect of one or more exemplary embodiments, there is provided a method of controlling a user terminal apparatus. The method may include: selecting user preferred contents based on a user input of contents; arranging and displaying the user preferred contents according to preference degrees of the user preferred contents; and when the preference degrees of the user preferred contents are changed, changing and displaying arrangement states of the user preferred contents based on the changed preference degrees.

The user input of the contents may be at least one of a setting control of the contents reflecting user preferences for the contents, an editing control of the contents, a sharing control of the contents, and a content generation-related control.

The method may further include additionally storing and managing the user preferred contents in a preset preferred content folder.

Arrangement states of the user preferred contents may be changed and displayed in the preset preferred content folder according to user preference degrees of the user preferred contents.

The method may further include: communicating with an SNS server; and providing a visual feedback that is to change sizes of user preferred contents displayed in the preset preferred content folder in real time, based on feedbacks of other users on user preferred contents uploaded to the SNS server.

The method may further include: displaying a UI that synchronizes and provides the feedbacks of the other users on the user preferred contents uploaded to the SNS server in real time.

The method may further include: communicating with a cloud server; and automatically backing the user preferred contents stored in the preset preferred content folder up to the cloud server.

The method further include: when a user command to display preferred content folders of the other users is input, displaying a screen comprising preferred contents of the other users included in preferred content folders of the other users.

The screen may include a time navigation GUI for selecting a time section for displaying preferred contents. The method may further include rearranging and displaying user preferred contents belonging to a time selection selected according to a user input of the time navigation GUI.

According to an aspect of one or more exemplary embodiments, there is provided a method of controlling a server. The method may include: communicating with a user terminal apparatus; storing information about user preferred contents of preset time sections received from the user terminal apparatus; and when there is a request of the user terminal apparatus, transmitting information about the user preferred contents corresponding to a time section corresponding to the request to the user terminal apparatus. The user preferred contents may be contents that are selected based on a user input of contents input from the user terminal apparatus.

As described above, according to one or more exemplary embodiments, user preferred contents that are selected based on content generating and consuming acts of users may be effectively managed.

In an aspect of one or more embodiments, there is provided at least one non-transitory computer readable medium storing computer readable instructions to implement methods of one or more embodiments.

### BRIEF DESCRIPTION OF THE DRAWINGS

The above and/or other aspects will become apparent and more readily appreciated from the following description with reference to the accompanying drawings, in which:

FIGS. 1A and 1B are a schematic view and a block diagram illustrating a user terminal apparatus according to an exemplary embodiment;

FIG. 2 is a block diagram illustrating a detailed structure of the user terminal apparatus of FIG. 1, according to an exemplary embodiment;

FIG. 3 is a block diagram illustrating a software structure stored in a storage unit, according to an exemplary embodiment;

FIGS. 4A through 4C are views illustrating a method of selecting and arranging preferred contents, according to an exemplary embodiment;

FIGS. 5A and 5B are views illustrating a method of providing a user interface (UI) according to an exemplary embodiment;

FIGS. 6A through 6D are views illustrating various menus that are provided in a preferred content folder, according to an exemplary embodiment;

FIGS. 7A and 7B are views illustrating a time navigating method according to an exemplary embodiment;

FIGS. 8A through 8C are views illustrating a method of sharing preferred contents of other users, according to an exemplary embodiment;

FIGS. 9A and 9B are views illustrating a method of displaying feedbacks of other users on user's preferred contents, according to an exemplary embodiment;

FIGS. 10 and 11 are views illustrating a method of displaying contents according to an exemplary embodiment;

FIGS. 12A through 12C are views illustrating a method of setting whether to open preferred contents, according to an exemplary embodiment;

FIG. 13 is a view illustrating a method of displaying music contents, according to an exemplary embodiment;

FIG. 14 is a flowchart illustrating a method of controlling a user terminal apparatus, according to an exemplary embodiment; and

FIG. 15 is a flowchart illustrating a method of controlling a server, according to an exemplary embodiment.

### DETAILED DESCRIPTION

Reference will now be made in detail to embodiments, examples of which are illustrated in the accompanying drawings, wherein like reference numerals refer to the like elements throughout.

In the following description, the matters discussed in the description, such as detailed construction and elements, are provided to assist in a comprehensive understanding of exemplary embodiments. Thus, it is apparent that exemplary embodiments can be carried out without those specifically discussed matters. Also, well-known functions or constructions are not described in detail since they would obscure exemplary embodiments with unnecessary detail.

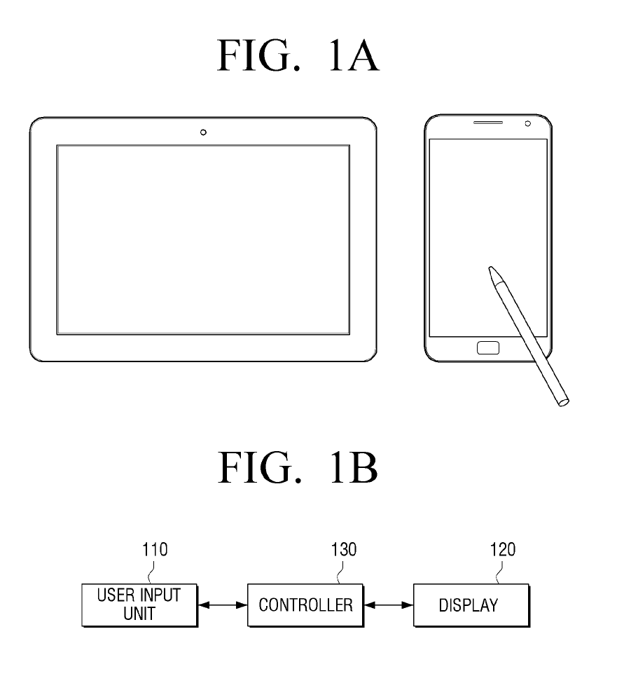

FIGS. 1A and 1B are a schematic view and a block diagram illustrating a user terminal apparatus according to an exemplary embodiment.

FIG. 1A is a schematic view illustrating a user terminal apparatus 100 according to an exemplary embodiment.

As shown in FIG. 1A, the user terminal apparatus 100 may be realized as a portable phone such as a smartphone or the like but is not limited thereto. The user terminal apparatus 100 may be realized as various types of apparatuses that are portable and have display functions like a tablet PC, a portable multimedia player (PMP), a personal digital assistant (PDA), a navigation system, etc. The user terminal apparatus 100 may also include a touch screen and may be realized to execute a program by using a finger or a pen (for example, a stylus pen)

The user terminal apparatus 100 may store and manage contents that are determined as user's preferred contents through various attachment acts of a user to contents, separately from other contents. The attachment acts to the contents may be realized as various control forms of the user that will be described later

The user terminal apparatus 100 may provide a user interface (UI) screen that displays the user's preferred contents separately from the other contents. The UI screen may be provided through a particular folder of a category to which the corresponding contents belong. For example, picture contents may be provided through a particular one of various folders that are provided in a gallery application providing the picture contents. An application may refer to software that is directly used by the user on an operating system (OS) and may be provided as an icon interface form on a screen of the user terminal apparatus 100

A structure of the user terminal apparatus 100 according to various exemplary embodiments will now be described in detail

FIG. 1B is a block diagram illustrating a structure of the user terminal apparatus 100, according to an exemplary embodiment.

Referring to FIG. 1B, the user terminal apparatus 100 includes a User input unit 110, a display unit 120, and a controller 130

The User input unit 110 receives various user commands.

In particular, the User input unit 110 may receive various user inputs of contents. The various user inputs of the contents may be various forms such as various setting controls of the contents, an editing control of the contents, a sharing control of the contents, etc.

The various user inputs of the contents received through the User input unit 110 may be used to select user's preferred contents. For example, a particular content may be selected as a preferred content by a user input for setting the particular content to a wallpaper.

The display unit 120 displays a screen. The screen may include various contents such as an image, a moving picture, a text, music, etc., an application execution screen including the various contents, a graphic user interface (GUI) screen, etc.

In particular, the display unit 120 may display a UI screen including only user's preferred contents of pre-stored contents according to a user command. The user's preferred contents (hereinafter referred to as preferred contents) may be selected based on various attachment acts of a user to contents, in detail, various user inputs of the contents received through the User input unit 110. A detailed method of selecting preferred contents will be described later with reference to the attached drawings.

The display unit 120 may be realized as a liquid crystal display panel (LCDP), an organic light-emitting diode (OLED), or the like but is not limited thereto. In particular, the display unit 110 may be realized as a touch screen that forms an interactive layer structure along with a touch pad. In this case, the display unit 120 may be used as the User input unit 110 besides an output device. The touch screen may be constituted to detect a touch input position, a touch input area, and a touch input pressure.

The controller 130 controls an overall operation of the user terminal apparatus 100.

A method of selecting user's preferred contents will now be described.

The controller 130 may select preferred contents based on various user inputs of contents.

The controller 130 may select the preferred contents based on various attachment acts of the user to contents, in detail, based on various setting controls of the contents, an editing control of the contents, a sharing control of the contents, a content generation-related control, etc. The contents may be various forms such as pictures, moving pictures, music, applications, etc. and will be hereinafter described as picture contents for convenience of description.

For example, the various setting controls of the contents may be a control of rating a picture content, a control of locking a screen displaying the picture content, a control of setting the picture content as a wallpaper, a profile photo, or the like, a control of setting a deletion locking function and a hiding function for the picture content, etc. Also, the editing control of the contents may be various editing controls such as a control of including a signature in the contents, scaling the contents down and/or up, etc. The sharing control of the contents may be a control of transmitting the contents to another user terminal apparatus and/or receiving the contents from the another user terminal apparatus, a control uploading the contents through an simple notification service (SNS), or the like. The content generation-related control may be a control of changing a setting value before capturing, a control of capturing a subject a plurality of times, or the like. Besides theses, a view control, a printing control, etc. may be included in user inputs. In this case, the control of rating the picture content, the control of locking the screen displaying the picture content, the control of setting the picture content to the wallpaper, the profile photo, or the like, etc. are explicit user inputs. However, various editing controls, such as the editing control of the contents, the control of including the signature in the contents, scaling the contents down and/or up, etc., may be implicit controls. Therefore, in one or more exemplary embodiments, user's explicit preference and implicit preference may be reflected to select preferred contents.

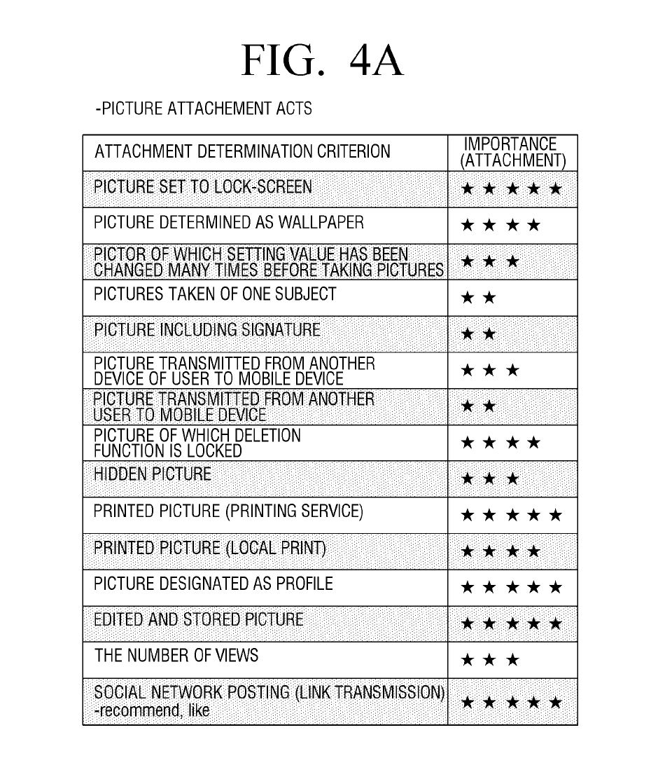

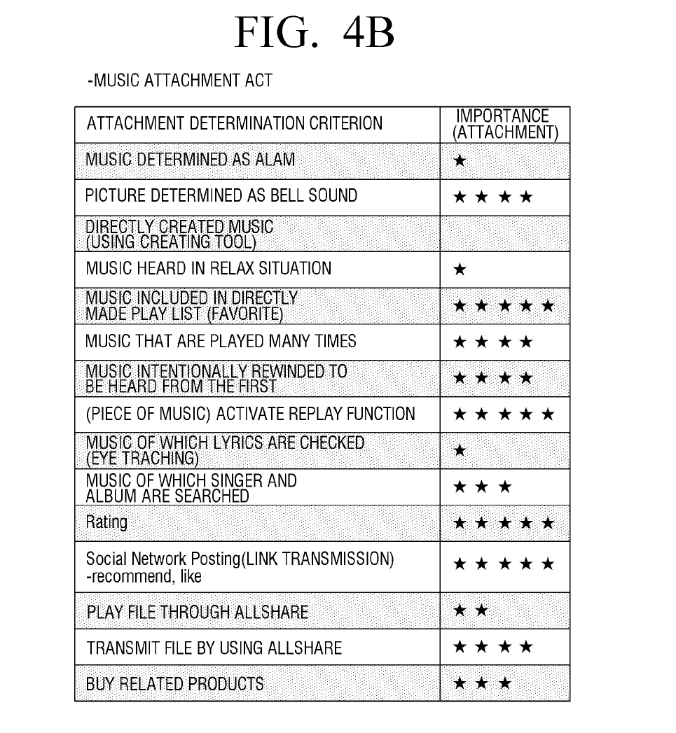

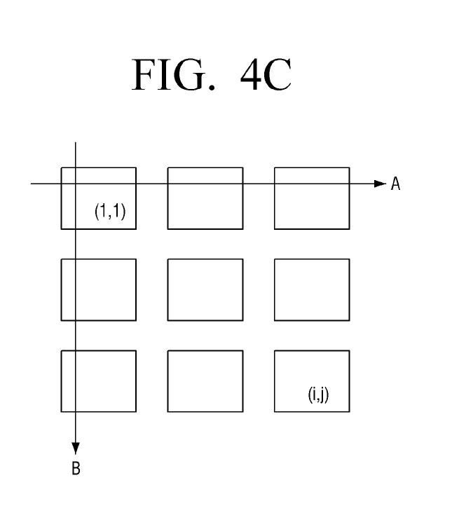

Preference (or attachment) degrees (levels) may be differently given to the various user inputs of the contents. For example, a preference of ★★★★★ level may be given to the control of setting the picture content to the wallpaper, and a preference of ★★ level may be given to the control of transmitting the picture content to the another user terminal apparatus. Preferences according to user inputs may be stored as the default in the user terminal apparatus 100 (refer to FIG. 4A). However, the preferences according to the user inputs may be changed according to user's setting or may be updated through an external server. Also, preference degree may be differently given to the music content according to various user inputs corresponding to the music content (refer to FIG. 4B), but this is only an example, and thus a detailed description thereof is omitted.

The controller 130 may select preferred contents of pre-stored contents based on the preference degrees according to the user inputs and manage the contents according to the preference degrees of the preferred contents.

The controller 130 may select the preferred contents of the pre-stored contents by the preset number (for example, 100). In other words, the controller 130 may select and manage the preset number of contents as preferred contents in high preference orders based on preference degrees respectively given to the contents. However, this is only an example, and the number of preferred contents is not limited, and thus the preferred contents may be selected based on the preference degrees. For example, all of contents having preferences higher than or equal to ★★★ may be selected as preferred contents regardless of the number of contents.

A method of managing and displaying user's preferred contents will now be described.

The controller 130 may manage preferred contents selected by the above-described method through an additional folder.

The controller 130 may separate and provide only preferred contents through a preferred content folder of a category to which the corresponding contents belong. For example, a preferred content folder (hereinafter referred to as a Faves folder) may be additionally provided in a gallery application providing picture contents to store and manage the picture contents in the Faves folder.

For example, if picture 1 stored in a screenshot folder of a picture application is selected as a preferred content through a user input of the picture 1, the picture 1 may be automatically stored in a Faves folder. In other words, the picture 1 is stored in the screenshot folder and may also be automatically stored in the Faves folder. Therefore, the user may manage only preferred contents of the user through the Faves folder.

The controller 130 may determine arrangement states of the preferred contents in the Faves folder based on the preference degrees. The preference degrees may include a preference degree of the user and preference degrees of other users.

The controller 130 may arrange and display the preferred contents in the Faves folder according to the user's preference degree of the user terminal apparatus 100.

For example, referring to FIG. 4C, the controller 130 may arrange preferred contents from a content having the highest preference to contents having lower preferences from a left direction to a right direction (in an A direction) and then arrange preferred contents from an upper direction to a lower direction (in a B direction). In other words, the controller 130 may arrange a preferred content having a first order in position (1, 1), arrange a preferred content having a second order in position (1, 2) where j value is increased by 1, and arrange a preferred content in position (2, 1) wherein if the j value is maximum, i value is increased by 1. Contents that are not arranged to position (i, j) preset in the Faves folder may be automatically deleted from the Faves folder, and these arrangement states of preferred contents may be updated in real time whenever being changed.

The controller 130 may also change sizes of the preferred contents in the Faves folder according to the preference degrees of the other users and display the preferred contents having the changed sizes.

The controller 130 may provide visual feedbacks that change the sizes of the preferred contents displayed in the Faves folder based on feedbacks of the other users on preferred contents uploaded to an SNS server (not shown).

For example, if a comment of another user is written to picture 2 uploaded to the SNS server, a size of the picture 2 displayed in the Faves folder may be enlarged and displayed.

In this case, a picture size may be enlarged based on a ratio of an original picture. For example, a picture that is captured in a transverse mode may be enlarged and displayed in the transverse mode, and a picture that is captured in a longitudinal mode may be enlarged and displayed in the longitudinal mode.

Also, a picture may be enlarged in a square shape based on a feedback degree of another user. For example, if a picture that is captured in a transverse mode is enlarged in a rectangular shape of which a width is long, and an additional feedback of another user occurs, the picture may be enlarged and displayed in a square mode in which a width length is a side.

In this case, the enlargement degree may be determined based on the feedback degree of the another user. For example, if the feedback of the another user occurs two or more times, the picture may be enlarged and displayed in a longitudinal or transverse mode. If the feedback of the another user occurs five or more times, the picture may be enlarged and displayed in a square mode.

The controller 130 may also synchronize and provide feedbacks of the another user on the preferred contents uploaded to the SNS server in real time.

For example, if comments of other users are written to the picture 2 that is uploaded from the Faves folder to the SNS server, the controller 130 may synchronize the comments in real time to provide the synchronized comments on a screen. Therefore, the user may check the comments of the other users on the picture 2 without accessing an SNS screen.

The controller 130 may manage opened preferred contents of the preferred contents that are opened to another user separately from closed preferred contents that are not opened to the another user in the Faves folder. Therefore, although the Faves folder is set to be shared with the anther user, preferred contents that the user desires not to open may not be displayed in a terminal of the another user.

For example, the controller 130 may determine contents that are uploaded to the SNS server and preferred contents that are moved into the Faves folder through a menu (for example, menu “move to My Faves”) directly by the user as opened preferred contents, determine the other preferred contents as closed preferred contents, and separately manage the opened preferred contents and the closed preferred contents. Alternatively, the controller 130 may determine preferred contents that are locked through an additional lock menu as closed preferred contents, determine unlocked preferred contents as opened preferred contents, and separately manage the closed preferred contents and the opened preferred contents.

In this case, the controller 130 may display the opened preferred contents and the closed preferred contents to distinguish the opened preferred contents from the closed preferred contents in the Faves folder. For example, the controller 130 may display border parts of the closed preferred contents in inactive states to identify corresponding preferred contents as closed preferred contents.

The controller 130 may also separately manage preferred contents of each time section.

The controller 130 may display a time navigation GUI in the Faves folder, and arrange and display user preferred contents belong to a time section that is selected according to a user input of the time navigation GUI. Therefore, the user may conveniently enjoy past attached contents. Managing and storing of preferred contents of each time section may be performed by the user terminal apparatus 100 or may be performed through a cloud server (not shown) to reduce a memory burden.

In this case, the controller 130 may automatically back information about preferred contents additionally stored in the Faves folder up to the cloud server.

The controller 130 may generate arrangement, size, and identification information, etc. of the preferred contents as a link file in the Faves folder and back the generated link file and original preferred contents up to the cloud server. In this case, the cloud server may constitute each time section arrangement of the Faves folder based on the backed-up contents and synchronize the received link file with the user terminal apparatus 100. Also, whenever updating is performed in the Faves folder, synchronization may be performed between the cloud server and the user terminal apparatus 100 based on a request message.

If a time navigation is performed through the time navigation GUI, the controller 130 may transmit a query to the cloud server based on a link file corresponding to a navigated time section, and download and arrange corresponding preferred contents.

However, the above-described exemplary embodiment is only an example, and the controller 130 may store and manage preferred contents in the user terminal apparatus 100, and manage only a link file of the preferred contents through the cloud server.

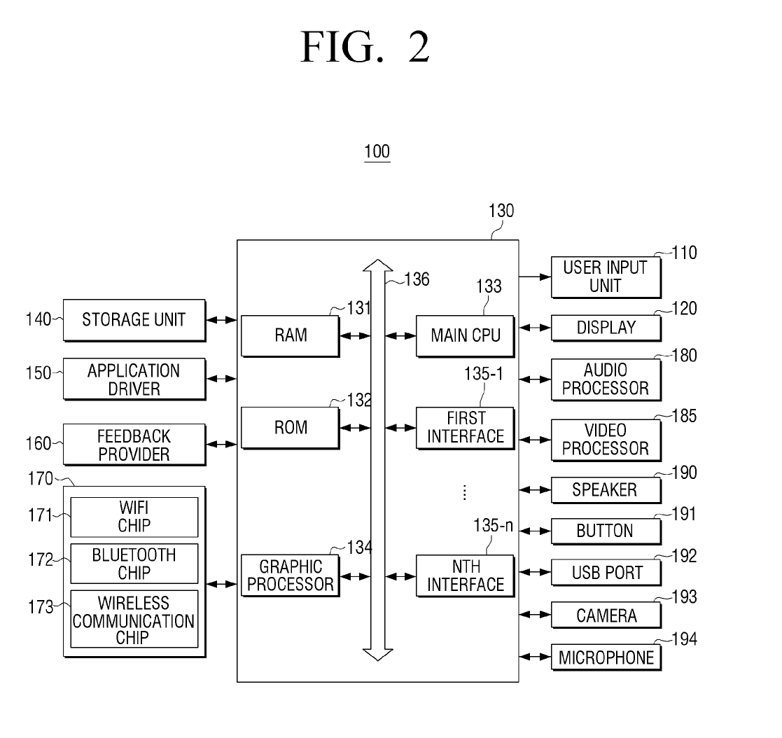

FIG. 2 is a block diagram illustrating a detailed structure of the user terminal apparatus 100 of FIG. 1, according to an exemplary embodiment. Referring to FIG. 2, the user terminal apparatus 100 includes a user interface (UI) unit (user interface) 110, a display unit (display) 120, a controller 130, a storage unit (storage) 140, an application driver 150, a feedback provider 160, a communicator 170, an audio processor 180, a video processor 185, a speaker 190, a button 191, a universal serial bus (USB) port 192, a camera 193, and a microphone 194. Detailed descriptions of the same elements of FIG. 2 as those of FIG. 1 are omitted.

An operation of the controller 130 that are described above may be performed by a program stored in the storage unit 140. The storage unit 140 may store various types of data such as an operating system (O/S) software module for driving the user terminal apparatus 100, various types of applications, various types of contents input or set when executing applications, etc. In particular, contents stored in the storage unit 140 may be divided into preferred contents and general contents as described above.

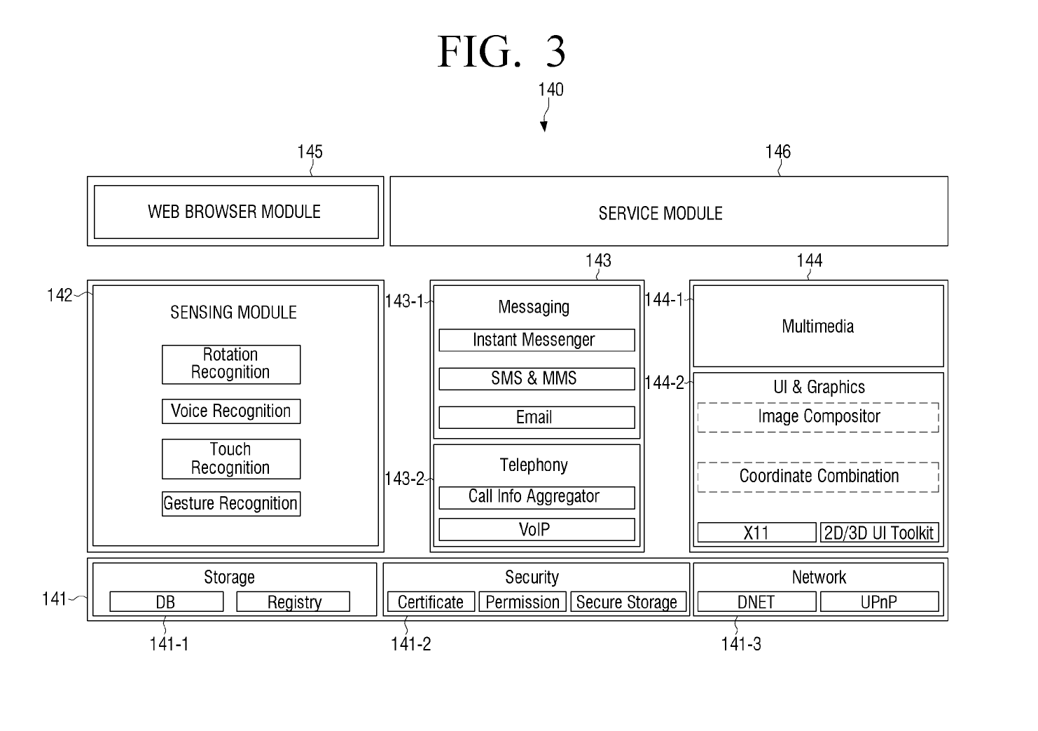

Various types of software modules stored in the storage unit 140 will be described later with reference to FIG. 3.

The application driver 150 drives and executes an application that may be provided by the user terminal apparatus 100. The application is an application program that is executed for itself and may include various types of multimedia contents. The multimedia contents include texts, audios, still images, animations, videos, interactive contents, electronic program guide (EPG) contents provided from a content provider, electronic messages received from users, information about a current event, etc. but are not limited thereto.

The feedback provider 160 provides various feedbacks according to a function executed in the user terminal apparatus 100.

In particular, the feedback provider 160 may provide a haptic feedback on a GUI displayed on a screen. The haptic feedback refers to a technology that generates vibrations, forces, or shocks in the user terminal apparatus 100 to allow a user to feel a sense of touch and thus is referred to as a computer haptic technology.

In detail, if arrangement states of preferred contents are changed according to a user preference degree or sizes of the preferred contents are changed based on a feedback of another user, the feedback provider 160 may provide a real-time haptic feedback.

In this case, the feedback provider 160 may differently apply vibration conditions (for example, a vibration frequency, a vibration length, a vibration intensity, a vibration waveform, a vibration position, etc.) to provide various feedbacks under control of the controller 130. A method of differently applying a vibration mode to generate various haptic feedbacks is an existing technology, and thus a detailed description thereof is omitted.

The feedback provider 160 provides a haptic feedback by using a vibration sensor in the above-described exemplary embodiment, but this is only an example. Therefore, the feedback provider 160 may provide the haptic feedback by using a piezo sensor.

The communicator 170 communicates with various types of external apparatuses according to various types of communication methods. The communicator 170 includes various types of communication chips such as a WiFi chip 171, a Bluetooth chip 172, a wireless communication chip 173, etc.

The WiFi chip 171 and the Bluetooth chip 172 respectively perform communications by using a WiFi method and a Bluetooth method. The wireless communication chip 173 performs communications according to various types of communication standards such as IEEE, Zigbee, 3rd Generation (3G), 3rd Generation Partnership (3GPP), etc. The communicator 170 may further include a near field communication (NFC) chip that operates according to a NFC method that uses a band of 13.56 MHz of various types of radio frequency identification (RFID) frequency bands such as 135 kHz, 13.56 MHz, 433 MHz, 860-960 MHz, 2.45 GHz, etc.

The communicator 170 may include a first communicator (not shown) that communicates with an SNS server (not shown) and a second communicator (not shown) that communicates with a cloud server (not shown). The first and second communicators may use the same communication method or may use different communication methods. For example, the first and second communicators may perform communications through the wireless communication chip 173.

The audio processor 180 processes audio data. The audio processor 170 may perform various types of processing, such as decoding, amplifying, noise filtering, etc., on the audio data.

The video processor 185 processes video data. The video processor 185 may perform various types of image processing, such as decoding, scaling, noise filtering, a frame rate conversion, a resolution conversion, etc., on the video data.

The speaker 190 outputs various types of audio data processed by the audio processor 180, various types of notification sounds, various types of voice messages, etc.

The button 191 may be various types of buttons such as a mechanical button, a touch pad, a wheel, etc. formed in an arbitrary area of a front part, a side part, a rear part, or the like of an outer surface of a main body of the user terminal apparatus 100. For example, a button for turning on/off power of the user terminal apparatus 100 may be provided.

The USB port 192 may communicate with and charge various types of external apparatuses through a USB cable.

The camera 193 captures a still image or a moving picture under control of the user. A plurality of cameras 193 including a front camera, a rear camera, etc. may be realized.

The microphone 194 receives a user voice or other sounds and converts the user voice or the other sounds into audio data. The controller 130 may use the user voice input through the microphone 194 in a call process or convert the user voice into audio data and store the audio data in the storage unit 140.

If the camera 193 and the microphone 194 are provided, the controller 130 may perform a control operation according to the user voice input through the microphone 194 or a user motion recognized by the camera 193. In other words, the user terminal apparatus 100 may operate in a motion control mode or a voice control mode. If the user terminal apparatus 100 operates in the motion control mode, the controller 130 activates the camera 193 to capture the user and tracks motion changes of the user to perform a control operation corresponding to the motion changes. If the user terminal apparatus 100 operates in the voice control mode, the controller 130 may operate in a voice recognition mode in which the user voice input through the microphone 194 is analyzed, and a control operation is performed according to the analyzed user voice.

The user terminal apparatus 100 may further include various types of external input ports to be connected to various types of external terminals such as a headset, a mouse, a local area network, etc.

The controller 130 controls an overall operation of the user terminal apparatus 100 by using various types of programs stored in the storage unit 140.

For example, the controller 130 may execute an application stored in the storage unit 140 to constitute and display an execution screen of the application or may play various types of contents stored in the storage unit 140. The controller 130 may also communicate with external apparatuses through the communicator 170.

The controller 130 includes a random access memory (RAM) 131, a read only memory (ROM) 132, a main central processing unit (133), a graphic processor 134, and first through n^{th} interfaces 135-1 through 135-n.

The RAM 131, the ROM 132, the main CPU 133, the graphic processor 134, and the first through n^{th} interfaces 135-1 through 135-n may be connected to one another through a bus 136.

The first through n^{th} interfaces 135-1 through 135-n are connected to various types of elements that are described above. One of the first through n^{th} interfaces 135-1 through 135-n may be a network interface that is connected to an external apparatus through a network.

The main CPU 133 accesses the storage unit 140 to perform booting by using the O/S stored in the storage unit 140. The main CPU 122 performs various operations by using various types of programs, contents, data, etc. stored in the storage unit 140.

The ROM 132 stores a command set, etc. for booting a system. If a turn-on command is input, and thus power is supplied, the main CPU 133 copies the O/S stored in the storage unit 140 into the RAM 131 and executes the O/S to boot the system. If the system is completely booted, the main CPU 133 copies various types of application programs stored in the storage unit 140 into the RAM 131 and executes the application programs copied into the RAM 131 to perform various types of operations.

The graphic processor 134 generates a screen including various types objects, such as an icon, an image, a text, etc., by using a calculator (not shown) and a renderer (not shown). The calculator calculates attribute values, such as coordinate values at which objects are to be displayed, and shapes, sizes, colors, etc. of the objects according to a layout of the screen by using a control command received from the graphic processor 134. The renderer generates a screen that includes objects and has various layouts, based on the attribute values calculated by the calculator. The screen generated by the renderer is displayed in a display area of the User input unit 110.

Although not shown in FIG. 2, the user terminal apparatus 100 may further include a sensor (not shown).

The sensor may sense various controls such as a touch on the user terminal apparatus 100, a rotation and a gradient of the user terminal apparatus 100, a pressure on the user terminal apparatus 100, an access to the user terminal apparatus 100, etc.

In particular, the sensor may include a touch sensor that senses touches. The touch sensor may be realized as a capacitive touch sensor or a resistive touch sensor. The capacitive touch sensor senses micro-electricity that is excited into a body of a user when a part of the body of the user is touched on the User input unit 110, by using a dielectric coated on a surface of the User input unit 110 to calculate touch coordinates. Since the resistive touch sensor includes two electrode plates, upper and lower electrode plates contact each other at the touched point to sense a flowing current in order to calculate touch coordinates. As described above, the touch sensor may be realized in various forms. The sensor may further include a geomagnetic sensor that senses a rotation state, a movement direction, etc. of the user terminal apparatus 100, an acceleration sensor that senses an inclined degree of the user terminal apparatus 100, etc.

FIG. 2 illustrates examples of detailed elements of the user terminal apparatus 100. According to exemplary embodiments, some of the elements of FIG. 2 may be omitted or changed, or other elements may be further added. For example, the user terminal apparatus 100 may further includes a global positioning system (GPS) receiver (not shown) that receives a GPS signal from a GPS satellite to calculate a current position of the user terminal apparatus 100, a digital multimedia broadcasting (DMB) receiver (not shown) that receives and processes a DMB signal, etc.

FIG. 3 is a block diagram illustrating a software structure stored in the storage unit 140, according to an exemplary embodiment.

Referring to FIG. 3, the storage unit 140 may store a base module 141, a sensing module 142, a communication module 143, a presentation module 144, a web browser module 145, and a service module 146.

The base module 141 processes a signal transmitted from each hardware of the user terminal apparatus 100 and transmits the processed signal to an upper layer module. The base module 141 includes a storage module 141-1, a security module 141-2, a network module 141-3, etc. The storage module 141-1 is a program module that manages a database (DB) or a registry. The main CPU 133 accesses the DB of the storage unit 140 by using the storage module 141-1 to read various types of data. The security module 141-2 is a program module that supports a certification, a permission, a secure storage of the hardware, etc. The network module 141-3 supports a network connection and includes a DNET module, an UPnP module, etc.

The sensing module 142 collects information from various types of sensors, and analyzes and manages the collected information. The sensing module 142 may include a face recognition module, a voice recognition module, a motion recognition module, an NFC recognition module, etc.

The communication module 143 communicates with an external apparatus. The communication module 143 may include a messaging module 143-1, such as a messenger program, a short message service (SMS) & (multimedia message service (MMS) program, an email program, etc., and a telephony module 143-2 including a call info aggregator program module, a VoIP module, etc.

The presentation module 144 constitutes a display screen. The presentation module 144 includes a multimedia module 144-1 that plays and outputs multimedia contents and a UI rendering module 144-2 that processes a UI and a graphic. The multimedia module 144-1 may include a player module, a camcorder module, a sound processor module, etc. Therefore, the multimedia module 144-1 plays various types of multimedia contents to generate and play a screen and a sound. The UI rendering module 144-2 may include an image compositor module that combines images, a coordinate combination module that combines and generates coordinates on a screen that is to display an image, an X11 module that receives various types of events from hardware, a 2-dimensional (2D)/3-dimensional (3D) UI toolkit that provides a tool for constituting a 3D UI, etc.

The web browser module 145 performs web browsing to access a web server. The web browser module 145 may include various types of modules such as a web view module that constitutes a webpage, a download agent module that performs downloading, a bookmark module, a webkit module, etc.

The service module 146 includes various types of applications for providing various services. The service module 146 may include various types of program modules such as a navigation program, a content play program, a game program, an electronic book program, a calendar program, an alarm management program, other widgets, etc.

Various types of program modules are illustrated in FIG. 3, but some of the various types of program modules may be omitted, changed, or added according to a type and a characteristic of the user terminal apparatus 100. For example, the storage unit 140 may further include a position-based module that operates along with hardware such as a GPS chip to support a position-based service.

FIGS. 4A through 4C are views illustrating a method of selecting preferred contents and a method of arranging preferred contents, according to an exemplary embodiment.

FIGS. 4A and 4B are views illustrating preference degrees that are set to user inputs corresponding to types of contents. FIG. 4C is a view illustrating a method of arranging preferred contents according to preference degrees respectively set to preferred contents. The methods of FIGS. 4A through 4C are as described above, and thus their detailed descriptions are omitted.

A method of providing various types of screens according to various exemplary embodiments will now be described with reference to the attached drawings. For convenience of description, picture contents will be described.

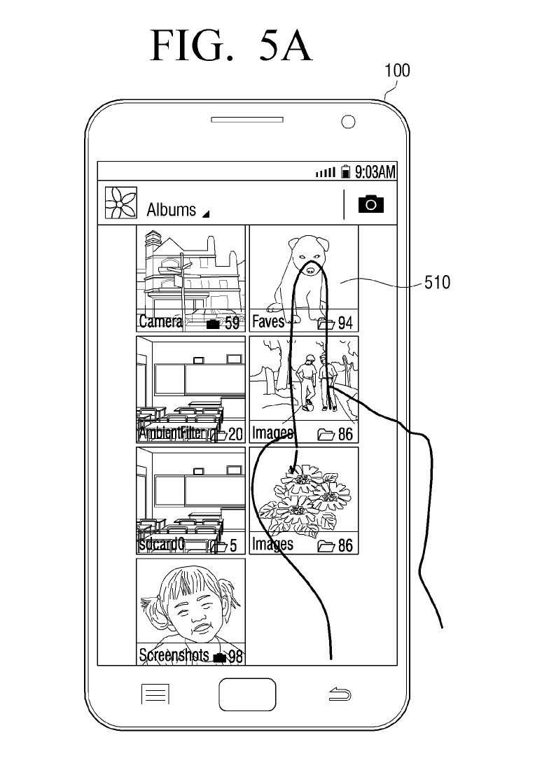

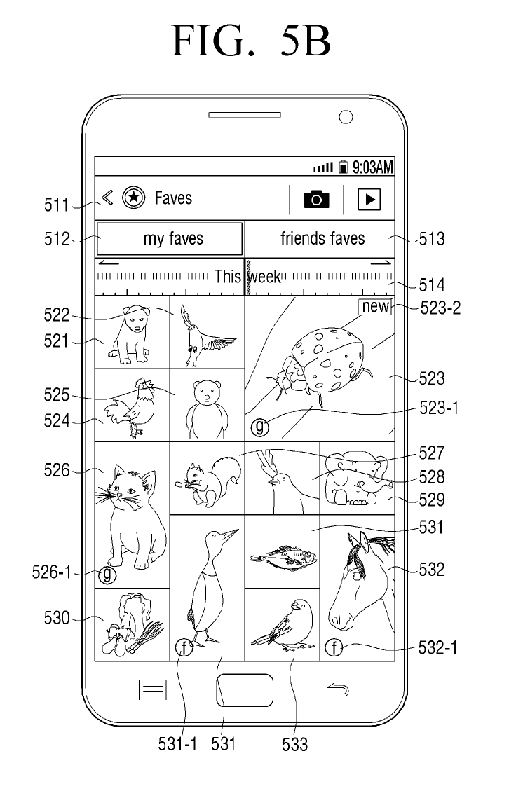

FIGS. 5A and 5B are views illustrating a method of providing a UI according to an embodiment.

As shown in FIG. 5A, a Faves folder that stores preferred contents according to an exemplary embodiment may be provided in one of various folder forms that are provided through a picture application.

As shown in FIG. 5A, if a user drives a picture application, various types of folders that are managed through the picture application may be provided. Among the various types of folders, a Faves folder 510 that stores preferred contents may be provided (e.g. favorites folder).

If the Faves folder 510 is selected on a UI screen shown in FIG. 5A, the preferred contents stored in the Faves folder 510 may be arranged and displayed.

As shown in FIG. 5B, a title area 511 is provided in an uppermost area of a screen to display a folder title. Also, “may faves” menu 512 that displays preferred contents of the user and “friends faves” 513 that display information about preferred contents of other users may be displayed in a lower area adjacent to the title area 511. A time navigation GUI 515 that provides a time navigation function of a display of preferred contents may be displayed in an area lower than the “my faves” menu 512 and the “friends faves” 513. If the “my faves” menu 512 is selected, preferred contents 521 through 533 may be arranged and displayed under the time navigation GUI 514 according to a preset criterion. The preset criterion may be a preference degree of the user for preferred contents. Preferences of the other users may be reflected to display the preferred contents 521 through 533 in various shapes and sizes.

For example, the preferred contents 523, 526, 531, and 532 uploaded to an SNS may respectively display SNS logos 523-1, 526-1, 531-1, and 532-1 to be displayed separately from the other preferred contents. In this case, sizes of the preferred contents uploaded to the SNS are enlarged based on feedbacks (comments) of the other users. In detail, if the feedbacks of the other users exceed a preset first number, sizes of the preferred contents 526, 531, and 532 uploaded to the SNS may be enlarged. In this case, the sizes of the preferred contents 526, 531, and 532 may be enlarged based on ratios of original pictures. In other words, original pictures of the enlarged preferred contents 526, 531, and 532 are in a longitudinal mode, the preferred contents 526, 531, and 532 may be enlarged in the longitudinal mode. Also, if the feedbacks of the other users exceed the preset first number and then exceed a preset second number due to an additional feedback, the preferred content 523 uploaded to the SNS may be enlarged in a square shape.

Although not shown in FIGS. 5A and 5B, a sharing service for a Faves folder may be provided through an external cloud server (not shown) not through the SNS. Therefore, picture sizes may be enlarged based on feedbacks of other users through the external cloud server.

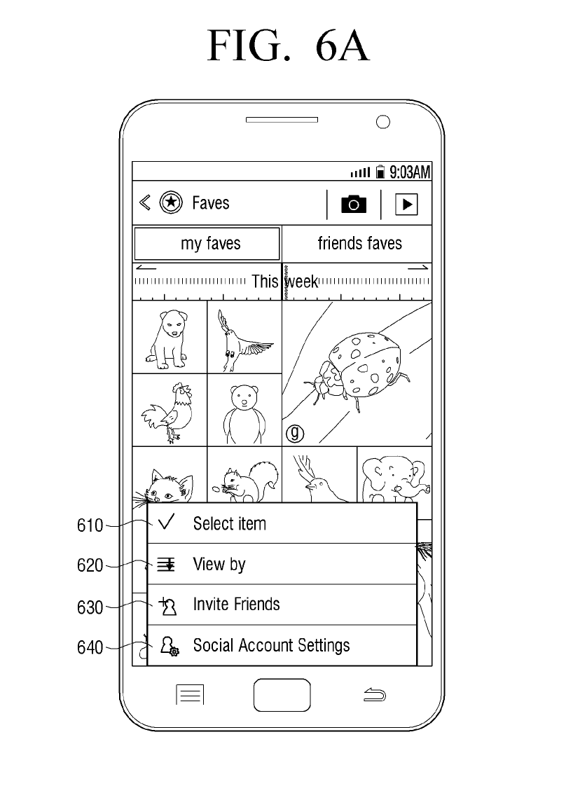

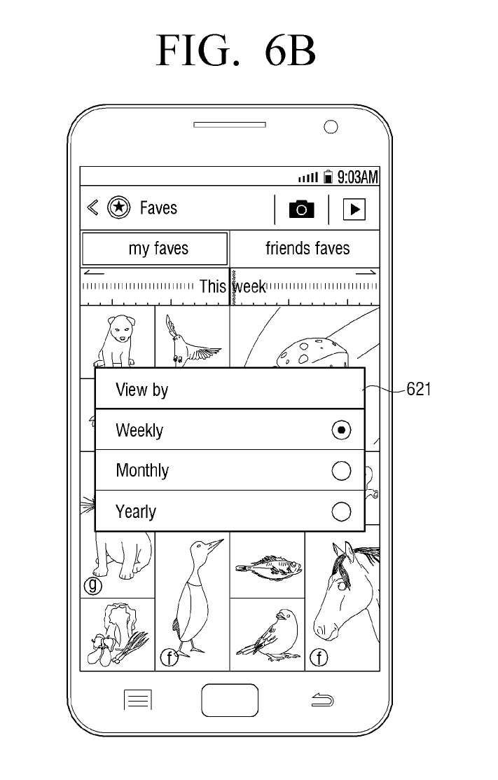

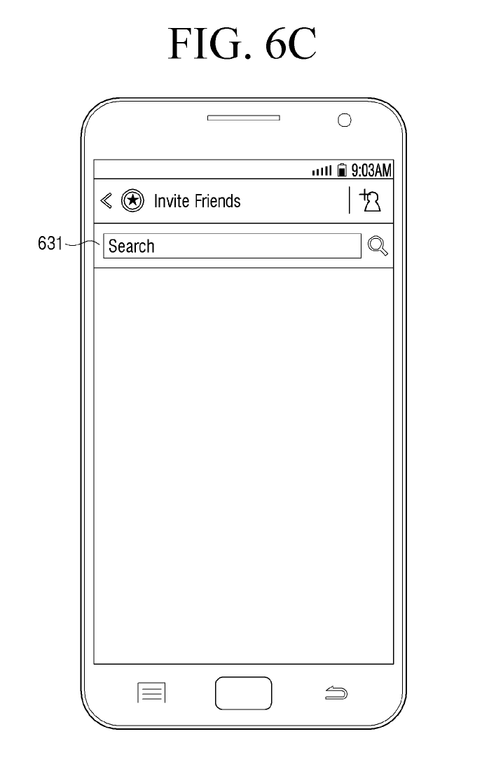

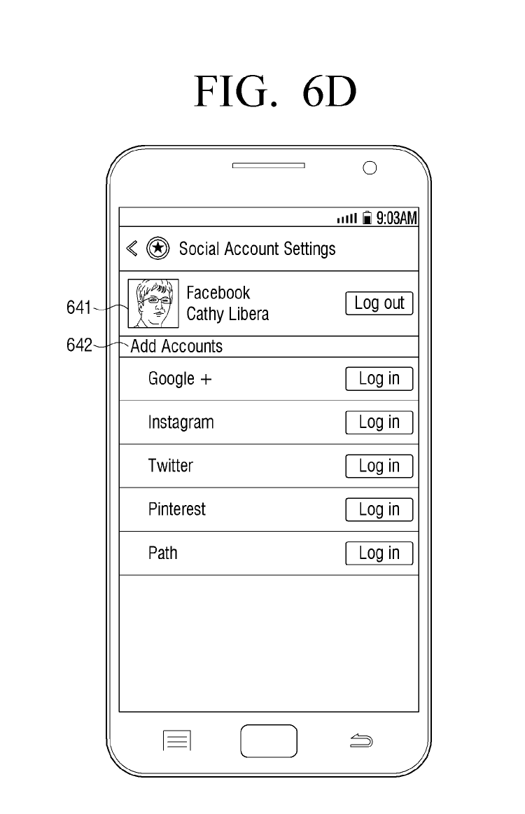

FIGS. 6A through 6D are views illustrating various menus that are provided in a preferred content folder, according to an exemplary embodiment.

As shown in FIG. 6A, various menus may be provided in a Faves folder. For example, a select item menu 610, a view by menu 620, an invite friends menu 630, and a social account settings menu 640 may be provided.

FIG. 6B is a view illustrating a screen on which the view by menu 620 is selected. As shown in FIG. 6B, if the view by menu 620 is selected, a menu 621 for selecting a time criterion at which a preferred content is to be displayed may be displayed. For example, a weekly preferred content may be displayed by “Weekly View” menu, a monthly preferred content may be displayed by “Monthly View” menu, and a yearly preferred content may be displayed by “Yearly View” menu.

FIG. 6C is a view illustrating a screen on which the invite friends menu 630 is selected. As shown in FIG. 6C, if the invite friends menu 630 is selected, a UI screen 631 through which other users may be searched may be displayed. Therefore, the user may invite a friend to share a Faves folder of the user with the friend or to share a Faves folder of the friend.

FIG. 6D is a view illustrating a screen on which the social account settings menu 640 is selected. As shown in FIG. 6D, if the social account settings menu 640 is selected, a screen for setting various SNS accounts may be displayed. In detail, a UI screen including a UI 641 and a UI 642 may be displayed. The UI 641 is used to log in and/or out of a preset SNS account, and the UI 642 is used to add a new SNS account. Through the corresponding screen, a user may log in or log out of a preset SNS account or may add or delete the SNS account. The user may also add or delete an SNS account and log in or log out of the SNS account through a setting screen (for example, each SNS application setting screen or a screen provided through a setting application providing an additional setting menu) that is additionally provided in the user terminal apparatus 100.

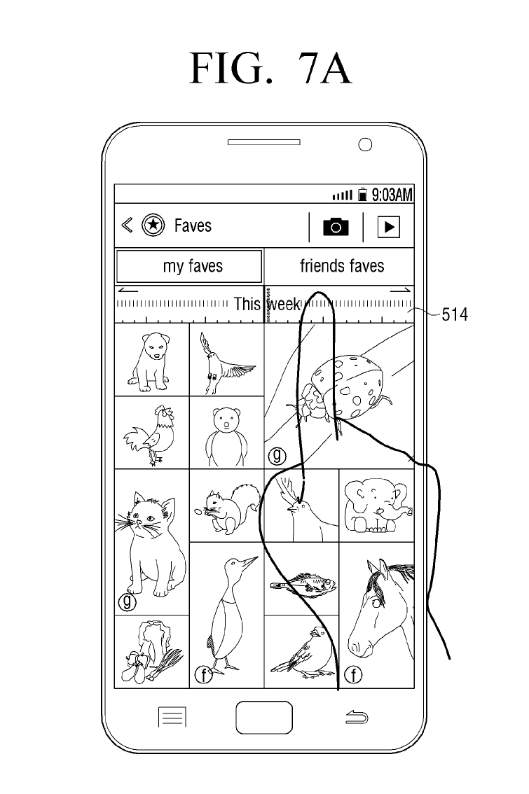

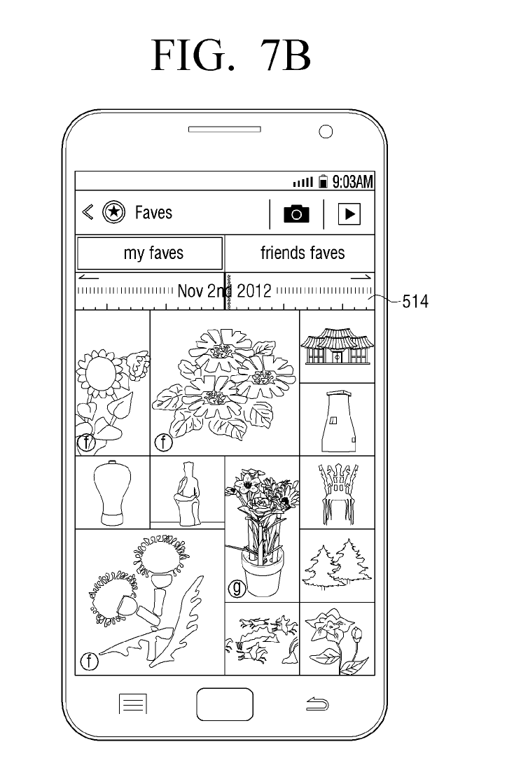

FIGS. 7A and 7B are views illustrating a time navigating method according to an exemplary embodiment.

As shown in FIGS. 7A and 7B, a time navigation GUI 514 displayed on a screen is navigated to display a preferred content corresponding to a time section desired by a user.

As shown in FIG. 7A, a Faves folder is selected, an initial screen may display a preferred content corresponding to “This week”.

As shown in FIG. 7B, if a second week of November, 2012 is selected according to a user input of the time navigation GUI 514, preferred contents in the corresponding time section may be displayed. In this case, a preferred content display through a time navigation may be performed by a communication with a cloud server (not shown) as described above, and thus a detailed description thereof is omitted.

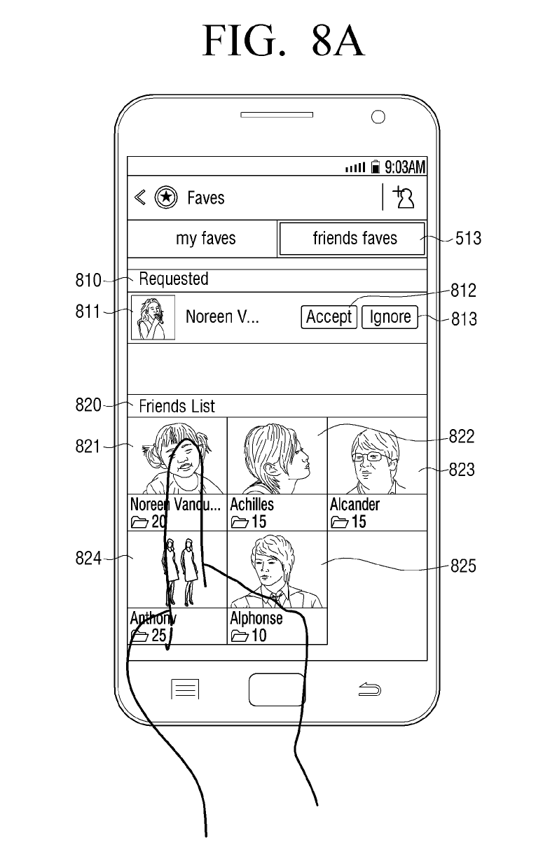

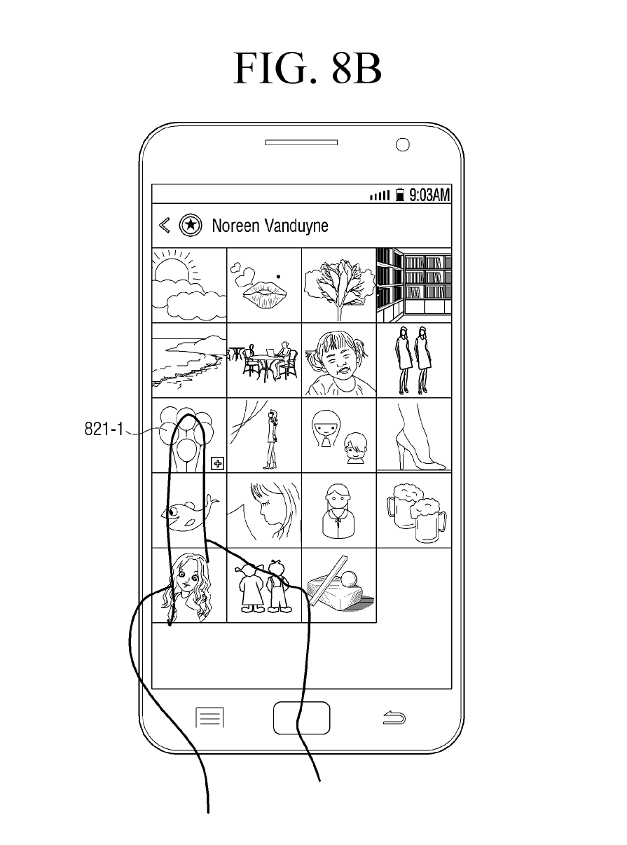

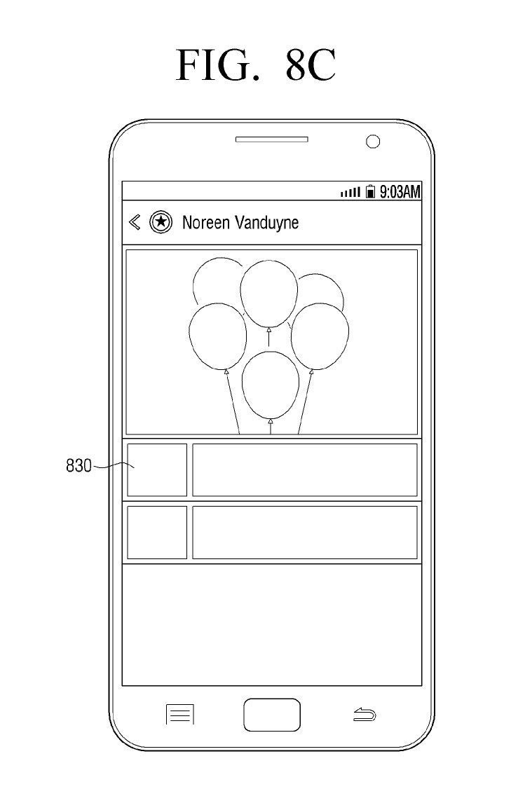

FIGS. 8A through 8C are views illustrating a method of sharing a preferred content of another user according to an exemplary embodiment.

As shown in FIG. 8A, if “friend faves” menu 513 provided in a Faves folder is selected, “Requested” menu 810 and “Friends List” menu 820 may be displayed. The “Request” menu 810 is a menu item that displays a request for sharing a Faves folder of another user, and the “Friends List” menu 820 is a menu item that displays a list of other users who share a current Faves folder with a user.

In detail, a list 811 of other users who request to share the Faves folder and items 812 and 813 for permitting or neglecting the corresponding request may be displayed in the “Requested” menu 810.

Lists 821 through 825 of other users who share the current Faves folder may be displayed in the “Friends List” menu 820. In this case, the lists 821 through 825 may be displayed in forms including thumbnails indicating representative contents (the most preferred contents) of Faves folders of the other users but are not limited thereto.

If a user selects a particular another user item 821 in the “Friends List” menu 820, a Faves folder screen of the corresponding another user may be displayed as shown in FIG. 8B. In other words, preferred contents of another user may be arranged and displayed on a Faves folder screen of the another user. Therefore, the user may share a Faves folder of the another user.

Also, a particular preferred content 821-1 may be selected on the Faves folder screen of the another user to provide a feedback on the particular preferred content 821-1. For example, if the particular preferred content 821-1 is selected, a UI 830 through which a comment on the particular preferred content 821-1 may be input may be provided as shown in FIG. 8C. The input comment may be uploaded to a related SNS server or a cloud server. In other words, if the particular preferred content 821-1 selected on the Faves folder screen of the another user is a content uploaded to an SNS, and the user inputs a comment through a corresponding UI, the corresponding comment may be managed in the corresponding Faves folder and synchronized with an SNS to be uploaded to the SNS. Therefore, the user may check the comment on the particular preferred content 821-1 through the corresponding Faves folder, but the corresponding comment on the particular preferred content 821-1 may be input on a timeline of the SNS. The timeline refers to a part that collects and displays comments of the user and friends.

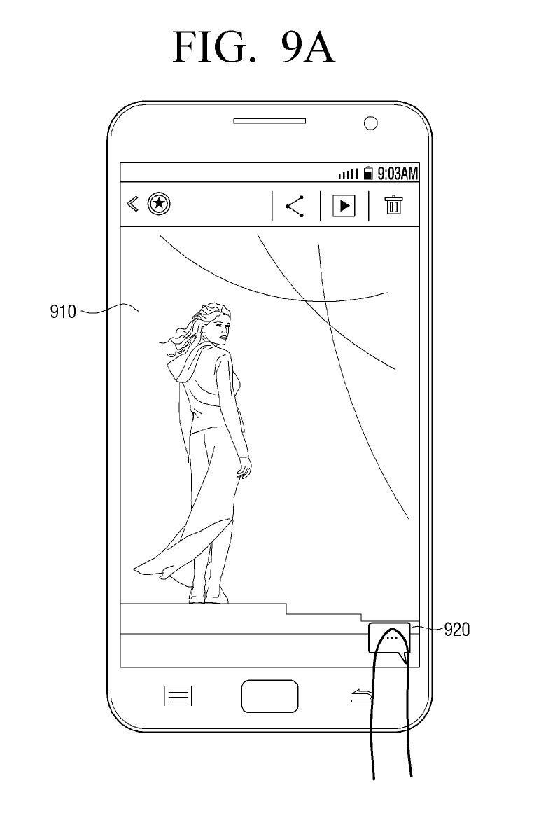

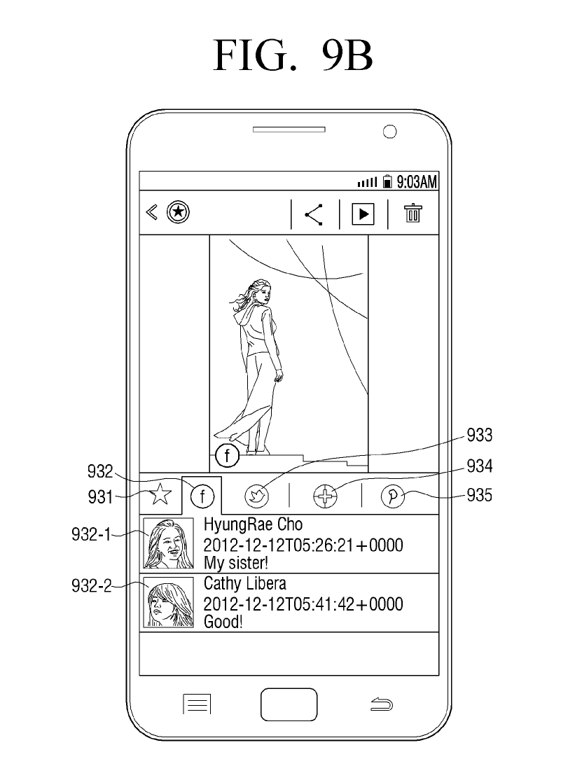

FIGS. 9A and 9B are views illustrating a method of displaying a feedback of another user on a user's preferred content according to an exemplary embodiment.

As shown in FIG. 9A, when a particular preferred content 910 may be selected in a Faves folder of a user, and a size of the particular preferred content 910 is maximized, an icon 920 indicating that there is a feedback of another user on the particular preferred content 910 may be displayed.

If the icon 920 is selected by the user, a screen that provides a feedback of another user on the particular preferred content 910 may be displayed. In detail, SNS logos 931 through 935 for selecting various SNS feedbacks may be displayed in an area of the screen. Also, if one of the SNS logos 931 through 935 is selected, timelines 932-1 and 932-2 indicating feedback contents of other users uploaded to a corresponding SNS server may be displayed. As shown in FIG. 9B, the timeline 932-1 and 932-2 may include comments of the user.

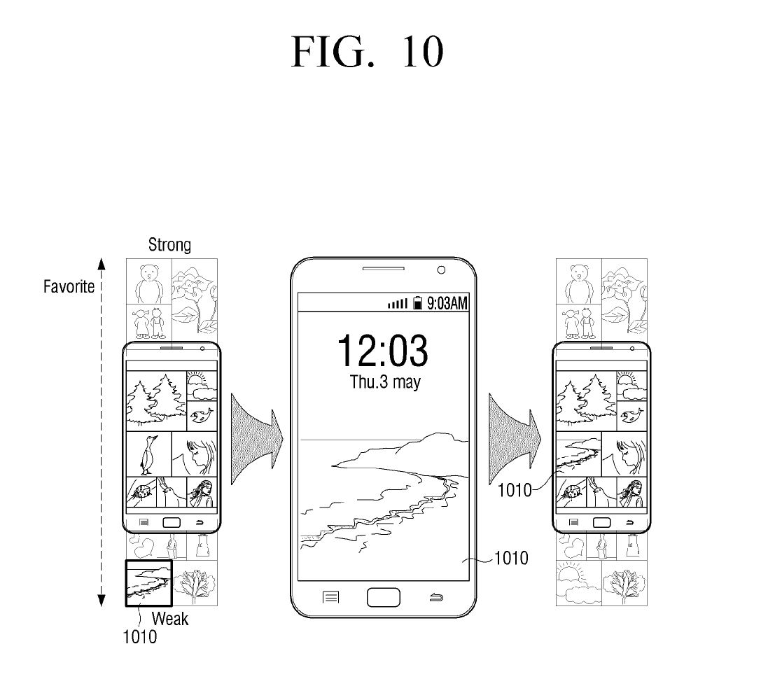

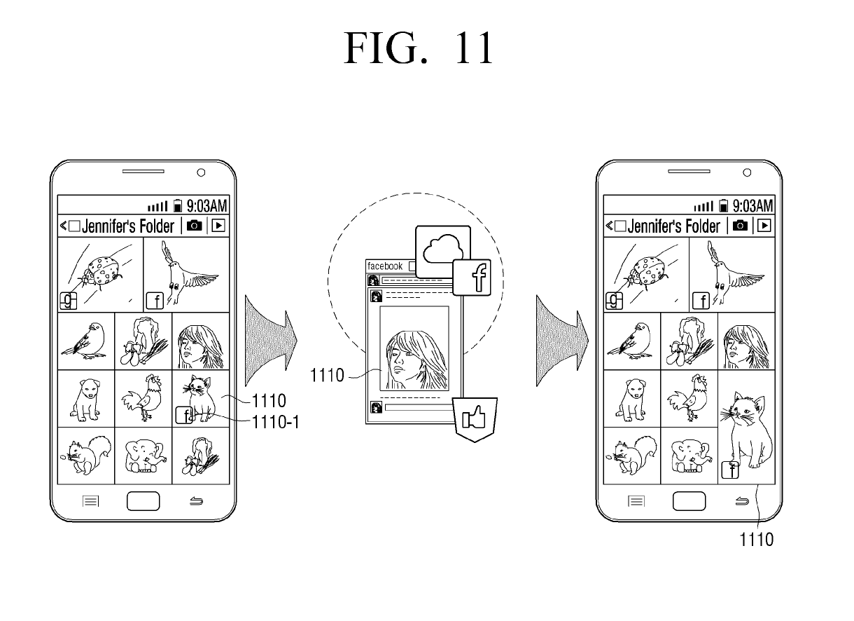

FIGS. 10 and 11 are views illustrating a method of displaying preferred contents according to an exemplary embodiment.

As shown in a left part of FIG. 10, orders of preferred contents may be determined based on preference degrees of a user.

As shown in the center of FIG. 10, if there is an attachment act to a particular preferred content 1010, i.e., a control of setting the particular preferred content 1010 to a wallpaper, a preference degree of the particular preferred content 1010 may be changed.

In this case, as shown in a right part of FIG. 10, an order of the particular preferred content 1010 of which preference degree has been changed may be changed and displayed.

As shown in a left part of FIG. 11, if there is a feedback of another user on a particular preferred content 1110 of preferred contents, i.e., an SNS comment, a size of the particular preferred content 1110 may be changed and displayed. In other words, as shown in the center of FIG. 11, the size of the particular preferred content 1110 may be enlarged and displayed.

In this case, as shown in a right part of FIG. 11, an order of the particular preferred content 1110 of which preference degree has been changed may be changed and displayed.

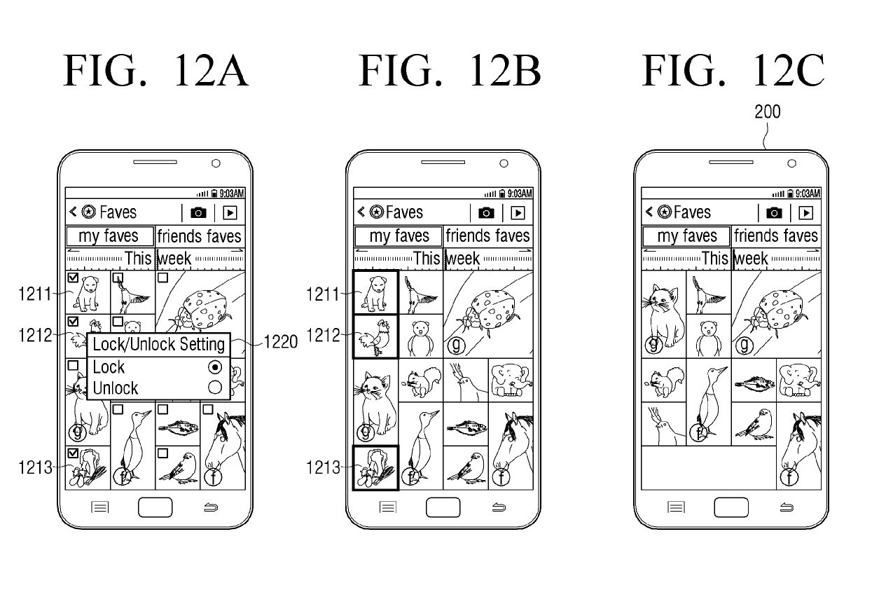

FIGS. 12A through 12C are views illustrating a method of setting a preferred content to be opened, according to an exemplary embodiment.

As shown in FIG. 12A, a user of the user terminal apparatus 100 may select a preferred content through the select item menu 610 of FIG. 6A and then set lock or unlock through menu 1220. In this case, a preferred content that is set to be locked may be set to a closed content, and a preferred content that is set to be unlocked may be set to an opened content.

For example, if preferred contents 1211, 1212, and 1213 are set to be locked, border parts of the preferred contents 1211, 1212, and 1213 may be displayed in inactive states (or in dark states) to display the preferred contents 1211, 1212, and 1213 separately from opened contents as shown in FIG. 12B.

FIG. 12C is a view illustrating a Faves folder of FIG. 12B that is displayed according to a request of another user in the user terminal apparatus 200. In this case, as shown in FIG. 12C, the preferred contents 1211, 1212, and 1213 that are set to be closed are not displayed on a screen of a terminal apparatus 200 of another user.

Opening and closing is set by lock and unlock settings in the above-described exemplary embodiment, but this is only an example. According to another exemplary embodiment, a content uploaded to an SNS server and a preferred content moved into a Faves folder directly by a user may be set to opened contents, and the other contents may be set to closed contents.

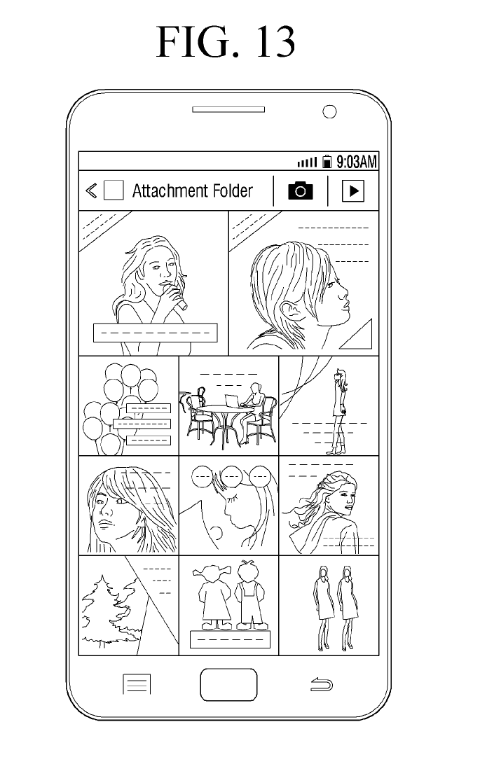

FIG. 13 is a view illustrating a method of displaying music contents according to an exemplary embodiment.

Music contents that are classified as preferred contents according to a criterion as shown in FIG. 4B may be additionally managed according to a similar method to that by which picture contents are managed. In other words, the music contents may be additionally stored and managed in one folder provided by a music application.

In this case, as shown in FIG. 13, album jacket images of the music contents may be arranged and displayed according to preference degrees of the music contents. Sizes of the album jacket images corresponding to the music contents may be changed and displayed based on feedbacks of other users on the music contents. The various exemplary embodiments that have been applied to the picture contents may be equally applied to the music contents, and thus their detailed descriptions are omitted.

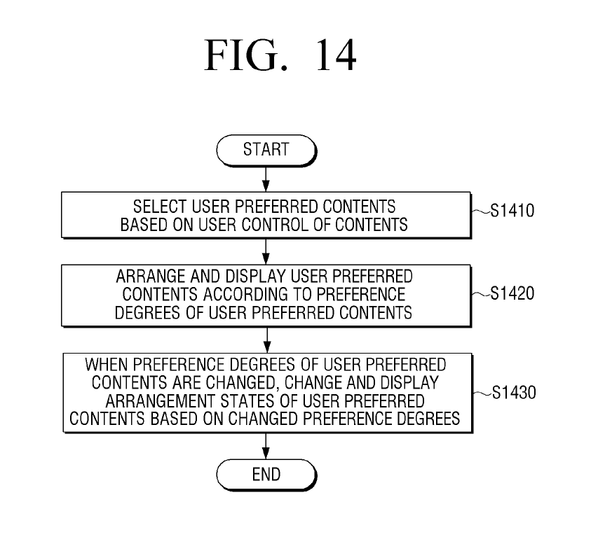

FIG. 14 is a flowchart of a method of controlling a user terminal apparatus according to an exemplary embodiment.

Referring to FIG. 14, in operation S1410, user preferred contents are selected based on a user input of contents.

In operation S1420, the user preferred contents are arranged and displayed according to preference degrees of the user preferred contents.

In operation S1430, if the preference degrees of the user preferred contents are changed, arrangement states of the user preferred contents are changed and displayed based on the changed preference degrees.

In this case, the user input of the contents may be at least one of a setting control of the contents that may reflect user preferences for the contents, an editing control of the contents, a sharing control of the contents, and a content generation-related control.

Also, the user preferred contents may be additionally stored and managed in a preset preferred content folder.

In addition, arrangement states of the user preferred contents may be changed and displayed in the preset preferred content folder according to the user preference degrees for the user preferred contents.

Sizes of the user preferred contents displayed in the preset preferred content may be changed in real time to provide visual feedbacks based on feedbacks of other users on the user preferred contents uploaded to an SNS server.

An UI that synchronizes and provides the feedbacks of the other users on the user preferred contents uploaded to the SNS server in real time.

The user preferred contents that are stored in the preset preferred content folder may be automatically backed up to a cloud server.

If a user command to display preferred content folders of the other users is input, a screen that includes preferred contents of the other users included in the preferred content folders of the other users may be displayed.

The displayed screen may also include a time navigation GUI for selecting a time section for displaying the preferred contents, and rearrange and display user preferred contents belonging to a time section selected according to a user input of the time navigation GUI.

Although not shown in the drawings, a server according to an exemplary embodiment may include a communicator that communicates with a user terminal apparatus, a storage unit that stores information about user preferred contents of respective preset time sections received from the user terminal apparatus, and a controller that, if there is a request of the user terminal apparatus, controls to transmit information about user preferred contents corresponding to a time section corresponding to the request to the user terminal apparatus. The user preferred contents may be contents that are selected based on a user input of contents input from the user terminal apparatus as described above, and the user input may be various attachment acts to the contents.

Also, information about preferred contents of users received from the user terminal apparatus may be a link file format including arrangement, size, identification information, etc. of the preferred contents. In addition, the server may back up and store contents according to time sections.

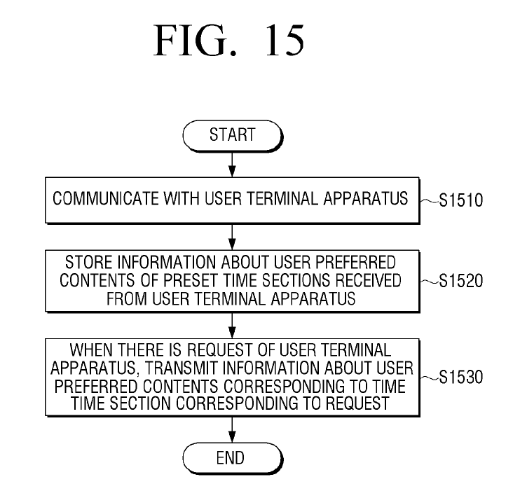

FIG. 15 is a flowchart of a method of controlling a server, according to an exemplary embodiment.

Referring to FIG. 15, in operation S1510, the server communicates with a user terminal apparatus. The user terminal apparatus may access the server to allow the server and the user terminal apparatus to communicate with each other.

In operation S1520, the server stores information about user preferred contents of preset time sections received from the user terminal apparatus.

If there is a request of the user terminal apparatus, the server may transmit information about user preferred contents corresponding to a time section corresponding to the request to the user terminal apparatus in operation S1530. The user preferred contents may be contents that are selected based on a user input of contents input from the user terminal apparatus.

As described above, according to exemplary embodiments, attached contents may be automatically selected and managed through natural content generating and consuming acts of users.

A method of controlling a user terminal apparatus or a server according to the above-described exemplary embodiments may be embodied as computer-readable instructions such as a program and then may be provided to the user terminal apparatus or the server.

For example, there may be provided a non-transitory computer-readable medium that stores computer readable instructions (such as a program) that when executed by at least one processor for example provides a structure that displays a screen including user preferred contents selected based on a user input, and changes and displays arrangement states of the user preferred contents according to preference degrees of the user preferred contents.

The non-transitory computer-readable medium refers to a medium which does not store data for a short time such as a register, a cache memory, a memory, or the like but semi-permanently stores data and is readable by a device. The above-described applications or programs may be stored and provided on a non-transitory computer readable medium such as a CD, a DVD, a hard disk, a blue-ray disk, a universal serial bus (USB), a memory card, a ROM, or the like.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs including but not limited to a blue-ray disk; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

The above exemplary embodiments and advantages are merely exemplary and are not to be construed as limiting. The above exemplary embodiments can be readily applied to other types of apparatuses and methods. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of embodiments, the scope of which is defined in the claims and their equivalents.

What is claimed is:

1. A user terminal comprising:
a user input unit to receive a user input of contents;
a display to display the contents; and
a controller to change display arrangement of the contents according to user preference degrees of the contents,
wherein the user preference degree is determined by the user input.

2. The user terminal of claim 1, wherein the user input of the contents is at least one of a setting control of the contents reflecting the user preference degrees of the contents, an editing control of the contents, a sharing control of the contents, and a content generation-relation control.

3. The user terminal of claim 1, wherein the controller additionally stores and manages a user preferred contents which is selected based on the user input in a preset preferred content folder.

4. The user terminal of claim 3, wherein the controller changes and displays arrangement states of the user preferred contents in the preset preferred content folder according to the user preference degrees of the user preferred contents.

5. The user terminal of claim 3, further comprising:
a first communicator to communicate with a social network service (SNS) server,
wherein the controller provides a visual feedback that is to change sizes of the user preferred contents displayed in the preset preferred content folder in real time based on feedbacks of other users on user preferred contents uploaded to the SNS server.

6. The user terminal of claim 5, wherein the controller displays a UI that synchronizes and provides the feedbacks of the other users on the user preferred contents uploaded to the SNS server in real time.

7. The user terminal of claim 3, further comprising:
a second communicator to communicate with a cloud server,
wherein the controller automatically backs the user preferred contents stored in the preset preferred content folder up to the cloud server.

8. The user terminal of claim 3, wherein when a user command to display preferred content folders of the other users is input, the controller displays a screen comprising preferred contents of the other users included in the preferred content folders of the other users.

9. The user terminal of claim 1, wherein:
the screen comprises a time navigation graphical user interface (GUI) to select a time section for displaying the contents according to the user preference degrees of the contents, and
wherein the controller rearranges and displays the contents belonging to a time section selected according to a user input of the time navigation GUI.

10. A server comprising:
a communicator to communicate with a user terminal;
a storage to store information about contents according to user preference degrees of the contents of preset time sections received from the user terminal; and
a controller, when there is a request of the user terminal, to control transmission of information about contents according to the user preference degrees of the contents corresponding to a time section corresponding to the request to the user terminal,
wherein the user preference degree is determined by a user input

11. A method of controlling a user terminal, the method comprising:
selecting contents based on a user input of contents;
changing display arrangement of the contents according to user preference degrees of contents; and
wherein the user preference degree is determined by the user input.

12. The method of claim 11, wherein the user input of the contents is at least one of a setting control of the contents reflecting the user preference degrees of the contents, an editing control of the contents, a sharing control of the contents, and a content generation-related control.

13. The method of claim 11, further comprising:
storing and managing a user preferred contents which is selected based on the user input in a preset preferred content folder.

14. The method of claim 13, wherein arrangement states of the user preferred contents are changed and displayed in the preset preferred content folder according to user preference degrees of the user preferred contents.

15. The method of claim 13, further comprising:
communicating with a social network service (SNS) server; and
providing a visual feedback that is to change sizes of user preferred contents displayed in the preset preferred content folder in real time, based on feedbacks of other users on user preferred contents uploaded to the SNS server.

16. The method of claim 15, further comprising:
displaying a UI that synchronizes and provides the feedbacks of the other users on the user preferred contents uploaded to the SNS server in real time.

17. The method of claim 13, further comprising:
communicating with a cloud server; and
automatically backing the user preferred contents stored in the preset preferred content folder up to the cloud server.

18. The method of claim 13, further comprising:
when a user command to display preferred content folders of the other users is input, displaying a screen comprising preferred contents of the other users included in preferred content folders of the other users.

19. The method of claim 11, wherein:
the screen comprises a time navigation GUI for selecting a time section for displaying the contents according to the user preference degrees of the contents, and
the method further comprises rearranging and displaying the contents belonging to a time selection selected according to a user input of the time navigation GUI.

20. A method of controlling a server, the method comprising:
communicating with a user terminal;
storing information about contents according to user preference degrees of the contents of preset time sections received from the user terminal; and
when there is a request of the user terminal, transmitting information about contents according to the user preference degrees of the contents corresponding to a time section corresponding to the request to the user terminal,
wherein the user preference degree is determined by a user input.

21. At least one computer readable medium storing computer readable instructions that control at least one processor to implement the method of claim 11.

22. At least one computer readable medium storing computer readable instructions that control at least one processor to implement the method of claim 20.
